(19) United States
(12) Patent Application Publication
(10) Pub. No.: US 2026/0070524 A1
(43) Pub. Date: Mar. 12, 2026

(54) System and Method for Spring Brake Monitoring for Truck-to-Trailer Electronic Brake System (EBS) Request Disabling

(71) Applicant: Knorr-Bremse AG, Munich (DE)

(72) Inventors: Joseph M. Goetz, Avon, OH (US); Joseph M. Macnamara, Ashland, OH (US); Stephania Lopez Tenorio, Lakewood, OH (US); John V. Ripley, Elyria, OH (US); Zeeshan Phansopkar, Elyria, OH (US)

(73) Assignee: Knorr-Bremse AG, Munich (DE)

(21) Appl. No.: 18/827,198

(22) Filed: Sep. 6, 2024

(51) Int. Cl. B60T 7/20; B60T 8/17; B60T 13/68

(52) U.S. Cl. CPC B60T 7/20; B60T 8/1708; B60T 13/683

(57) ABSTRACT

A system and method are provided for spring brake monitoring for truck-to-trailer electronic brake system (EBS) request disabling. In one embodiment, a brake controller in a trailer receives, from a tractor, an electronic brake signal to apply a service brake of the trailer. The brake controller determines whether pressurized air is being supplied to a spring brake of the trailer to release the spring brake. If pressurized air is being supplied to the spring brake of the trailer to release the spring brake, the brake controller causes the service brake of the trailer to be applied. However, if pressurized air is not being supplied to the spring brake of the trailer to release the spring brake, the brake controller takes no action in response to the electronic brake signal to apply the service brake of the trailer. Other embodiments are provided.

### BACKGROUND

“Compounding” refers to the situation in which a vehicle's service brake is applied when the vehicle's spring (parking) brake has not been released. Compounding can cause excessive brake wear and other damage. Some vehicles have an “anti-compounding” feature to prevent application of the service brake when the spring brake has not been released. For example, in some tractor-trailer vehicles in North America, the trailer has a trailer spring brake valve that allows pressurized control line air to flow to a control module to activate the service brake only when the valve also receives pressurized supply line air to release the spring brakes. As another example, in some tractor-trailer vehicles in Europe, anti-compounding is performed by an integrated parking chamber delivery and service relay valve that will send pressurized air to both the service brake (to apply the service brake) and the spring brake (to release the spring brake) in response to an electronic service brake request from an electronic brake system (EBS) in the tractor.

### BRIEF DESCRIPTION OF THE DRAWINGS

FIG. 1 is a diagram of a brake system of a vehicle of an embodiment.

FIG. 2 is a block diagram of an electronic control unit of an embodiment.

FIG. 3 is a flow chart of an anti-compounding method of an embodiment.

FIG. 4 is a diagram of a brake system of a vehicle of another embodiment.

FIG. 5 is a diagram of a prior art brake system.

### SUMMARY

In one embodiment, a non-transitory computer-readable storage medium is provided that stores a computer program having instructions that, when executed by one or more processors in a trailer in communication with a tractor, cause the one or more processors, individually or in combination, to: receive, from the tractor, an electronic brake signal to apply a service brake of the trailer; determine whether pressurized air is being supplied to a spring brake of the trailer to release the spring brake; in response to determining that pressurized air is being supplied to the spring brake of the trailer to release the spring brake, cause the service brake of the trailer to be applied; and in response to determining that pressurized air is not being supplied to the spring brake of the trailer to release the spring brake, take no action in response to the electronic brake signal to apply the service brake of the trailer.

In another embodiment, an anti-compounding method is provided that is performed in a vehicle. The method comprises: receiving an electronic request to apply a service brake of the vehicle; determining whether pressurized air is being supplied to a parking brake of the vehicle to un-park the vehicle; and granting the electronic request by allowing flow of pressurized air to the service brake of the vehicle only in response to determining that pressurized air is being supplied to the parking brake of the vehicle to un-park the vehicle.

In yet another embodiment, a brake system is provided comprising: a spring brake; a service brake; and means for preventing compounding of the spring brake and the service brake by disabling a truck-to-trailer electronic brake system (EBS) request in response to determining that pressurized air is not being supplied to release the spring brake.

Other embodiments are possible, and each of the embodiments can be used alone or together in combination.

### DETAILED DESCRIPTION

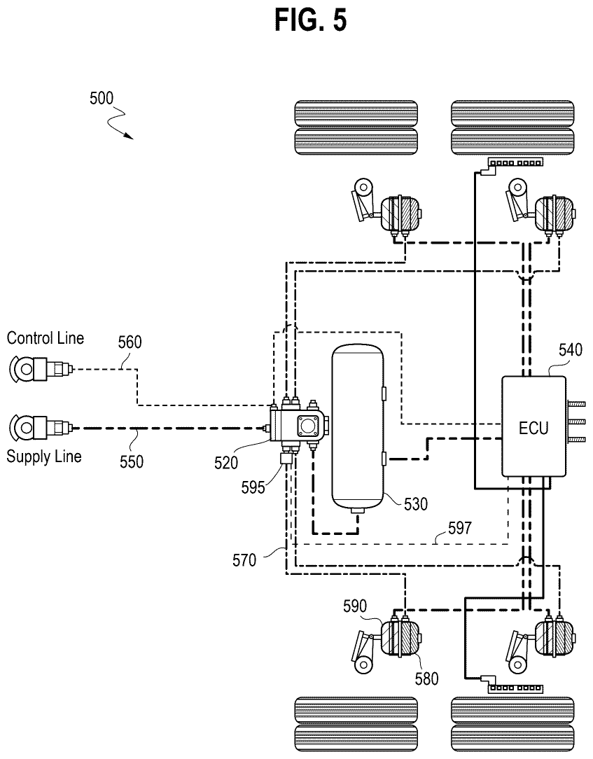

As mentioned above, in some tractor-trailer vehicles in North America, the trailer has a trailer spring brake valve that allows pressurized control line air to flow to a control module to activate the service brake only when the valve also receives pressurized supply line air to release the spring brake. FIG. 5 is an illustration of such a system 500. As shown in FIG. 5, this system 500 comprises a trailer spring brake valve (e.g., a Bendix SR-5™ Trailer Spring Brake Valve) 520, a pressurized air reservoir 530, an electronic control unit (ECU) (e.g., a Bendix TABS-6™ Advanced Multi-Channel (MC) Module) 540, a supply line 550 that supplies pressurized air from a tractor, and a control line 560 that supplies pressurized air from the tractor. To release the spring brake, the driver interacts with the appropriate user input device (e.g., a button) in the tractor to cause pressurized air to flow on the supply line 550 to the trailer spring brake valve 520, which allows the pressurized air to flow on line 570 to the spring brake chamber 580 to release the spring brake. The brake system 500 has a pressure switch 595 that detects whether a predetermined amount of pressure is being supplied on line 570 to the spring brake chamber. If the pressure switch 595 detects the predetermined amount of pressure, the pressure switch 595 sends an electronic signal (via wire 597) to the ECU 540. The ECU 540 can interpret a lack of this signal as a low-pressure warning emergency (LPWE).

To apply the service brakes, the driver presses the foot brake, which causes pressurized air to flow on the control line 560 to the trailer spring brake valve 520. If the trailer spring brake valve 520 is also receiving pressurized air from the supply line 550 (meaning that the spring brake is released), the trailer spring brake valve 520 allows the pressurized control air to flow to the ECU 540, which allows pressurized air from the reservoir 530 to flow to the service brake chamber 590 to apply the service brake. However, if the trailer spring brake valve 520 is not receiving pressurized air from the supply line 550 (meaning that the spring brake is not released), the trailer spring brake valve 520 does not allow the pressurized air from the control line 560 to flow to the ECU 540, thereby preventing the service brake from being applied (and, thus, performing anti-compounding). In this situation, the trailer spring brake valve 520 can vent the pressurized air from the control line 560 back into the supply line 550.

Although it is described herein that the service brakes are applied by the driver pressing the foot brake, it is to be understood that the service brakes may be applied by other means (e.g., trailer only, driver-assistance systems (DAS), electronic stability program (ESP)).

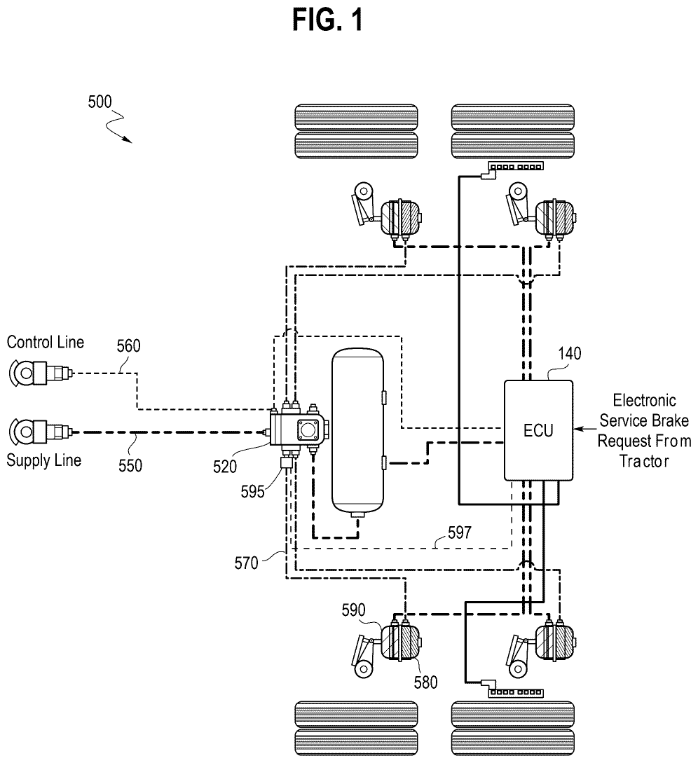

The inventors have discovered that the anti-compounding feature of this system 500 can be thwarted when this system is used in conjunction with an electronic brake system (EBS) that supports electronic braking from a towing vehicle to a towed vehicle. An electronic brake system in the tractor would provide an electronic signal to the ECU (on the trailer) to apply the service brake, thereby bypassing the anti-compounding protection provided by the trailer spring brake valve. To address this problem, the inventors have provided an embodiment in which feedback from the pressure switch(es) is used in a new anti-compounding feature. This embodiment will now be discussed in conjunction with the braking system 100 shown in FIG. 1. It should be noted that while this embodiment will be discussed in the context of a tractor (sometimes referred to herein as a truck or towing vehicle) coupled with a trailer, these embodiments can be used in any other types of vehicles that comprise a service brake and a spring/parking brake.

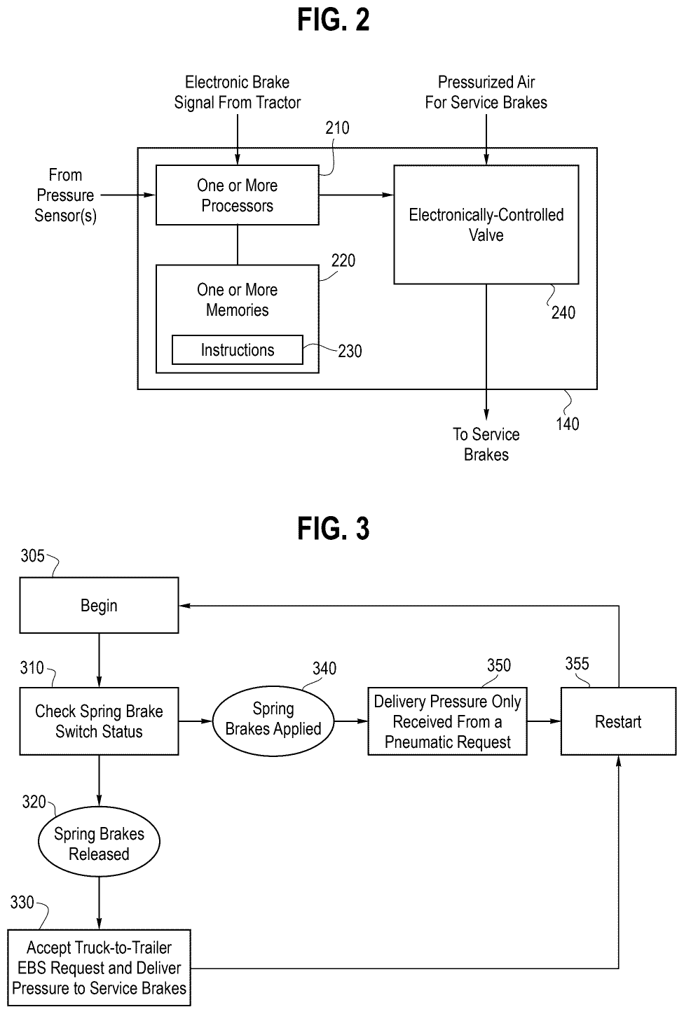

The brake system 100 in FIG. 1 is similar to the brake system 500 shown in FIG. 5 (with similar components similarly labeled). However, in the brake system 100 of this embodiment, a similar brake controller/ECU 140 is used that receives an electronic service brake request from the tractor and is configured (e.g., with software/firmware) to provide anti-compounding. FIG. 2 is a block diagram of the ECU 140 of this embodiment. As shown in FIG. 2, the ECU 140 comprises one or more processors 210, one or more non-transitory computer-readable memories (e.g., volatile or non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), and variants and combinations thereof), and an electronically-controlled valve (e.g., a solenoid valve) 240.

The one or more memories 220 (which may sometimes be referred to herein as “a non-transitory computer-readable storage medium,” where “medium” can refer to one or more memories) can store a computer program having instructions 230 (e.g., modules, routines, sub-routines, programs, applications, etc.) that, when executed by the one or more processors 210, individually or in combination, cause the one or more processors 210 to perform the anti-compounding function described below (and, optionally, other functions). The one or more processors 210 can also take the form of a purely-hardware implementation (e.g., an application-specific integrated circuit (ASIC)). The ECU 140 can comprise other components that are not shown in FIG. 2 to simplify the drawings.

In general, the ECU 140 is configured to receive, from the tractor, an electronic brake signal to apply a service brake of the trailer and determine whether pressurized air is being supplied to a spring brake of the trailer to release the spring brake. This determination can be made by determining whether the pressure switch 595 indicates that a predetermined amount of pressurized air (e.g., 66-70 PSI) is being supplied on the line to the spring brake chamber. Only one pressure switch is shown in FIG. 1, but it should be noted that multiple pressure switches (e.g., on the line(s) to other spring brake chamber(s)) can be used. Also, the pressure switch can be located in, on, or near the trailer spring brake valve; in, on, or near the spring brake chamber; or somewhere in between. Also, instead of using a pressure switch, a pressure sensor can be used, where the ECU 140 can be further configured to determine if the pressure value read by the pressure sensor is above a threshold.

If the ECU 140 determines that pressurized air is being supplied to the spring brake of the trailer to release the spring brake, the ECU 140 can cause the service brake of the trailer to be applied from an electronic service brake request. However, if the ECU 140 determines that pressurized air is not being supplied to the spring brake of the trailer to release the spring brake, the ECU 140 can take no action (e.g., ignore, disable, or block the request) in response to the electronic brake signal to apply the service brake of the trailer.

FIG. 3 is a flow chart 300 of an anti-compounding method of an embodiment. As shown in FIG. 3, after the method begins (305), the ECU 140 checks the spring brake switch status (310). If the spring brake switch indicates that the spring brakes are released (320), the ECU 140 accepts a truck-to-trailer electronic brake system (EBS) request and delivers pressure to the service brakes (330). However, if the spring brake switch indicates that the spring brakes are applied (340), delivery pressure is only received or accepted from a pneumatic request (350). However, the expected behavior of the spring brake valve is to return this pressure back to the supply line, where it is vented, thus the service brakes are not applied. After each branch of the flow, the method is restarted (355). In other embodiments, block (350) can be changed to prevent service brake applications from pneumatic or electronic requests.

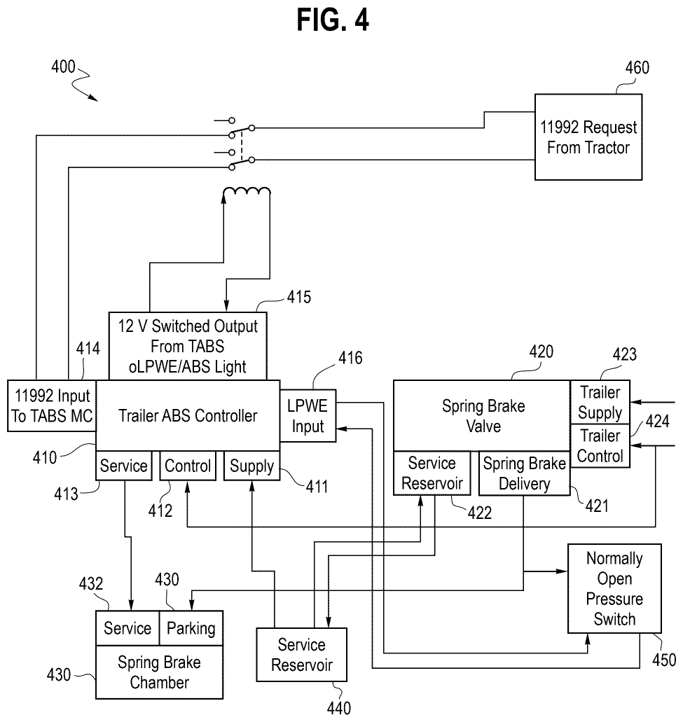

FIG. 4 is a diagram of a brake system 400 of another embodiment. As shown in FIG. 4, this brake system 400 comprises a trailer anti-lock braking system (ABS) controller 410, a spring brake valve 420, a spring brake chamber 430, a service reservoir 440, and a normally-open pressure switch 450. The trailer ABS controller 410 comprises a supply port 411, a control port 412, a service port 413, a 11992 input 414 (which receives a 11992 request from the tractor 460), a 12 V output 415, and an LPWE input 416. The spring brake valve 420 comprises a spring brake delivery port 421, a service reservoir port 422, a trailer supply port 423, and a trailer control port 424. The spring brake chamber 430 comprises a parking port 431 and a service port 432. These components operate to provide anti-compounding similar to the processes described above. It should be noted that this and the other architectures shown and described herein are merely examples and that other architectures can be used. As such, none of the details presented herein should be read into the claims unless expressly recited therein.

There are several advantages associated with these embodiments. For example, as discussed above, in North America, an anti-lock braking system (ABS) typically comprises an ABS relay valve and a parking brake valve. The parking brake valve releases the spring brakes when there is emergency pressure coming from the towing vehicle. The spring brake valve is also responsible for venting the control pressure for anti-compounding when the parking brakes are not released. This may present a problem when electronic brake signals are sent from the truck to the trailer. If the truck sends an electronic request even with a parked trailer, a compound brake apply is possible.

One embodiment disclosed herein uses a sensor at/in/near the parking brake valve that will indicate to the ABS relay valve that the spring brakes are released. This can also be accomplished by a smart parking brake valve that has built-in pressure sensors and communicates its status to the trailer ABS service relay valve. Compounding of the brakes is prevented during electronic brake requests, hence preventing potential damage to the brake chamber and wheel end. This can be accomplished with a combination of software and hardware. Monitoring spring brake status as an input to disable an EBS request signal sent towing-vehicle-to-trailer is novel, and the hardware to perform this at a basic level can be cost friendly. In an alternate embodiment, a smart spring brake valve can be used that has its own pressure sensors with limited hardware (e.g., a wire harness and a pressure switch connected to the delivery of the spring brake valve). The software and hardware of the trailer ABS service relay valve can monitor the circuit status to know the state of the spring brake and disable the tractor (or towing implement) EBS request when applicable. Although the spring brake valve 520 and ECU 140 are illustrated as separate components in FIG. 1, other embodiments in which the functionalities of the spring brake valve 520 and ECU 140 are combined into a single component are also contemplated.

It should be understood that all of the embodiments provided in this Detailed Description are merely examples and other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein. Additionally, “in response to” can be directly in response to or indirectly in response to.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A non-transitory computer-readable storage medium storing a computer program having instructions that, when executed by one or more processors in a towed vehicle in communication with a towing vehicle, cause the one or more processors, individually or in combination, to:
receive, from the towing vehicle, an electronic brake signal to apply a service brake of the towed vehicle;
determine whether pressurized air is being supplied to a spring brake of the towed vehicle to release the spring brake;
in response to determining that pressurized air is being supplied to the spring brake of the towed vehicle to release the spring brake, cause the service brake of the towed vehicle to be applied; and
in response to determining that pressurized air is not being supplied to the spring brake of the towed vehicle to release the spring brake, take no action in response to the electronic brake signal to apply the service brake of the towed vehicle.

2. The non-transitory computer-readable storage medium of claim 1, wherein the electronic brake signal is received from a foot brake module in the towing vehicle.

3. The non-transitory computer-readable storage medium of claim 1, wherein determining whether pressurized air is being supplied to the spring brake of the towed vehicle involves use of a pressure switch that indicates whether or not a predetermined amount of pressurized air is being supplied to the spring brake of the towed vehicle.

4. The non-transitory computer-readable storage medium of claim 1, wherein determining whether pressurized air is being supplied to the spring brake of the trailer comprises receiving a pressure reading from a pressure sensor and determining whether the pressure reading is greater than a threshold.

5. The non-transitory computer-readable storage medium of claim 1, wherein causing the service brake of the trailer to be applied comprises sending, to an electronically-controlled value, a signal configured to cause the electronically-controlled value to open.

6. The non-transitory computer-readable storage medium of claim 5, wherein taking no action in response to the electronic brake signal comprises not sending, to the electronically-controlled value in response to the electronic brake signal, the signal configured to cause the electronically-controlled value to open.

7. The non-transitory computer-readable storage medium of claim 5, wherein the electronically-controlled value comprises a solenoid valve.

8. The non-transitory computer-readable storage medium of claim 1, wherein the non-transitory computer-readable storage medium and the one or more processors are part of an electronic control unit (ECU) in the trailer.

9. The non-transitory computer-readable storage medium of claim 1, wherein the non-transitory computer-readable storage medium and the one or more processors are part of a trailer anti-lock brake system (ABS) controller.

10. An anti-compounding method comprising:
performing in a vehicle:
receiving an electronic request to apply a service brake of the vehicle;
determining whether pressurized air is being supplied to a parking brake of the vehicle to un-park the vehicle; and
granting the electronic request by allowing flow of pressurized air to the service brake of the vehicle only in response to determining that pressurized air is being supplied to the parking brake of the vehicle to un-park the vehicle.

11. The method of claim 10, wherein the electronic request is received in response to a foot brake being pressed.

12. The method of claim 10, wherein determining whether pressurized air is being supplied to the parking brake of the vehicle comprises receiving a signal from a pressure switch that indicates whether or not a predetermined amount of pressurized air is being supplied to the parking brake of the vehicle.

13. The method of claim 10, wherein determining whether pressurized air is being supplied to the parking brake of the vehicle comprises receiving a pressure reading from a pressure sensor and determining whether the pressure reading is greater than a threshold.

14. The method of claim 10, wherein allowing flow of pressurized air to the service brake comprises sending, to an electronically-controlled valve, a signal configured to cause the electronically-controlled valve to open.

15. The method of claim 13, wherein the electronically-controlled valve comprises a solenoid valve.

16. The method of claim 10, wherein the method is performed in an electronic control unit (ECU) in a trailer coupled with a tractor.

17. The method of claim 10, wherein the method is performed in a trailer anti-lock brake system (ABS) controller.

18. A brake system comprising:
a spring brake;
a service brake; and
means for preventing compounding of the spring brake and the service brake by disabling a truck-to-trailer electronic brake system (EBS) request in response to determining that pressurized air is not being supplied to release the spring brake.

19. The brake system of claim 18, further comprising a pressure switch or pressure sensor configured to provide an indication regarding whether or not the pressurized air is being supplied to release the spring brake.

20. The brake system of claim 18, wherein the means for preventing compounding comprising one or more processors.
